(19) United States
(12) Patent Application Publication
(10) Pub. No.: US 2005/0045661 A1
(43) Pub. Date: Mar. 3, 2005

(54) Caulking gun having washer positioning device

(76) Inventor: Wen-Sheng Huang, Taichung (TW)

Correspondence Address: Wen-Sheng Huang, 58, MA YUAN WEST ST., TAICHUNG, TW

(21) Appl. No.: 10/652,428

(22) Filed: Aug. 29, 2003

(51) Int. Cl. B67D 5/42

(52) U.S. Cl. 222/390

(57) ABSTRACT

A caulking gun includes a gun body, a plurality of washers mounted in the receiving barrel of the gun body, and a washer positioning device mounted on the washers and includes a thread extended through the through hole of each of the washers and having an upper end provided with a pull ring and a lower end formed with a fixing portion rested on a lowermost one of the washers. Thus, the lower end of the thread is directly formed with the fixing portion, so that the laminated washers are mounted on the thread easily and rapidly.

### BACKGROUND OF THE INVENTION

1. Field of the Invention

The present invention primarily relates to a caulking gun, and more particularly to a caulking gun having a washer positioning device.

2. Description of the Related Art

A conventional caulking gun comprises a gun body provided with a receiving barrel, a plurality of nails mounted in the receiving barrel of the gun body, and a trigger mounted on the gun body for ejecting the nails in the receiving barrel of the gun body outward. However, the striking force of trigger for ejecting the nails is too large, so that the nails will penetrate the article, thereby breaking or wearing the article.

Thus, the conventional caulking gun further comprises a plurality of washers mounted in the receiving barrel of the gun body, so that after the nails are ejected outward, each of the nails is locked on a respective one of the washers, and each of the nails and the respective washer are ejected outward simultaneously, so as to distribute the striking force for etching the nails. In addition, the nails can be combined with the article rigidly and stably by the larger area of each of the washers.

### SUMMARY OF THE INVENTION

The primary objective of the present invention is to provide a caulking gun having a washer positioning device.

Another objective of the present invention is to provide a caulking gun, wherein the thread made of plastic material is deformed when being heated or pressed, so that the lower end of the thread is deformed by a pressing or heating process to form the fixing portion, thereby facilitating assembly of the washers.

A further objective of the present invention is to provide a caulking gun, wherein the lower end of the thread is directly formed with the fixing portion, so that the laminated washers are mounted on the thread easily and rapidly.

A further objective of the present invention is to provide a caulking gun, wherein after the laminated washers are placed into the receiving barrel of the gun body, the pull ring of the thread is pulled upward, so that the thread is removed from the through hole of each of the washers, and the washers are mounted in the receiving barrel of the gun body easily and rapidly.

A further objective of the present invention is to provide a caulking gun, wherein the thread has a diameter slightly smaller than the diameter of the through hole of each of the washers, thereby increasing the mounting speed of the washers.

A further objective of the present invention is to provide a caulking gun, wherein the washers are clamped between the protrusion and the fixing portion of the thread to prevent the washers from detaching from the thread in the mounting process.

In accordance with the present invention, there is provided a caulking gun, comprising:
a gun body provided with a receiving barrel;
a plurality of washers mounted in the receiving barrel of the gun body; and
a washer positioning device mounted on the washers for positioning the washers.

Further benefits and advantages of the present invention will become apparent after a careful reading of the detailed description with appropriate reference to the accompanying drawings.

### BRIEF DESCRIPTION OF THE DRAWINGS

FIG. 1 is a partially cut-away perspective view of a caulking gun in accordance with the preferred embodiment of the present invention;

FIG. 2 is a partially exploded perspective view of the caulking gun in accordance with the preferred embodiment of the present invention;

FIG. 3 is a plan assembly view of the caulking gun as shown in FIG. 2;

FIG. 4 is a perspective assembly view of the caulking gun as shown in FIG. 2; and

FIG. 5 is a schematic operational view of the caulking gun as shown in FIG. 1.

### DETAILED DESCRIPTION OF THE INVENTION

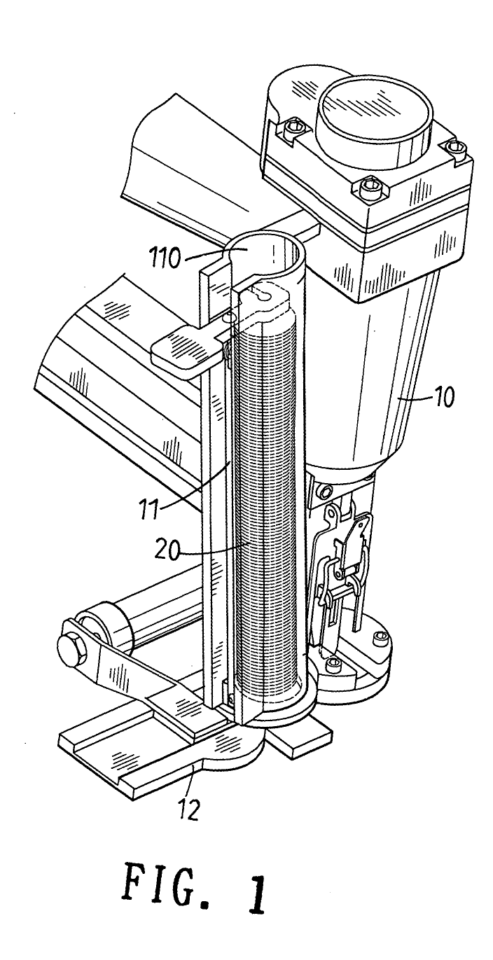

Referring to the drawings and initially to FIGS. 1-3, a caulking gun in accordance with the preferred embodiment of the present invention comprises a gun body 10 provided with a hollow receiving barrel 11, a plurality of washers 20 mounted in the receiving barrel 11 of the gun body 10, and a washer positioning device 3 mounted on the washers 20 for positioning the washers 20.

The receiving barrel 11 of the gun body 10 has an upper end formed with an opening 110 and a lower end connected to a feed mechanism 12.

In practice, each of the washers 20 contained in the receiving barrel 11 of the gun body 10 is pushed by the feed mechanism 12 to a nail ejection nozzle of the gun body 10 to combine with the nails. Thus, after the nails are ejected outward, each of the nails is locked on a respective one of the washers 20, so that each of the nails and the respective washer 20 are ejected outward simultaneously, so as to distribute the striking force for ejecting the nails. In addition, the nails can be combined with the article rigidly and stably by the larger area of each of the washers 20.

The washers 20 are laminated with each other, and each of the washers 20 has a center formed with a through hole 21.

The washer positioning device 3 includes a thread 30 extended through the through hole 21 of each of the washers 20 and having an upper end formed with a protrusion 32 rested on an uppermost one of the washers 20 and a lower end formed with a fixing portion 33 rested on a lowermost one of the washers 20, and a pull ring 31 secured on the upper end of the thread 30.

Preferably, the thread 30 is made of plastic material. In addition, the thread 30 is formed by a plastic injection molding process. In addition, the thread 30 has a diameter slightly smaller than a diameter of the through hole 21 of each of the washers 20. Preferably, the fixing portion 33 of the thread 30 is formed by a pressing or heating process and has a flattened shape.

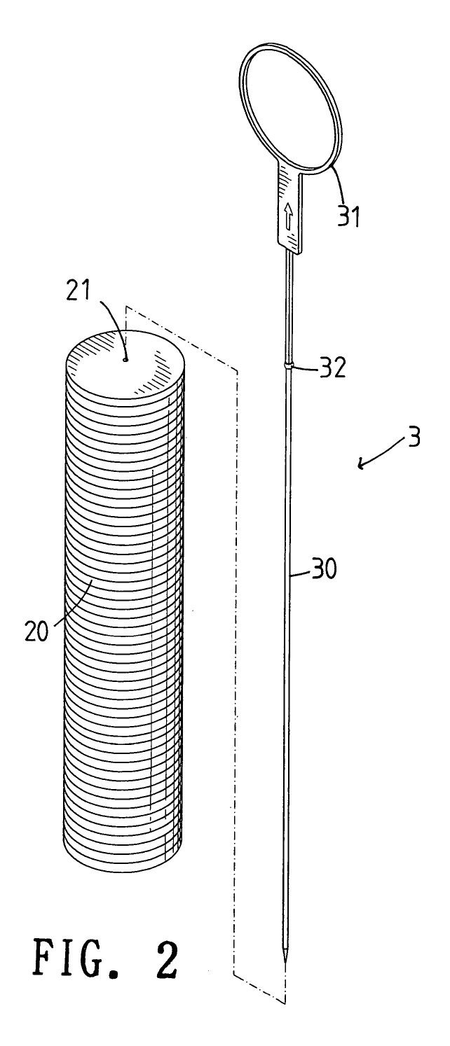

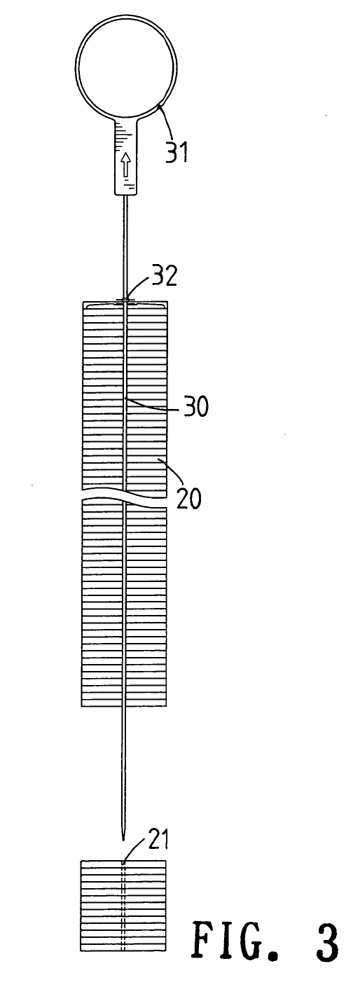

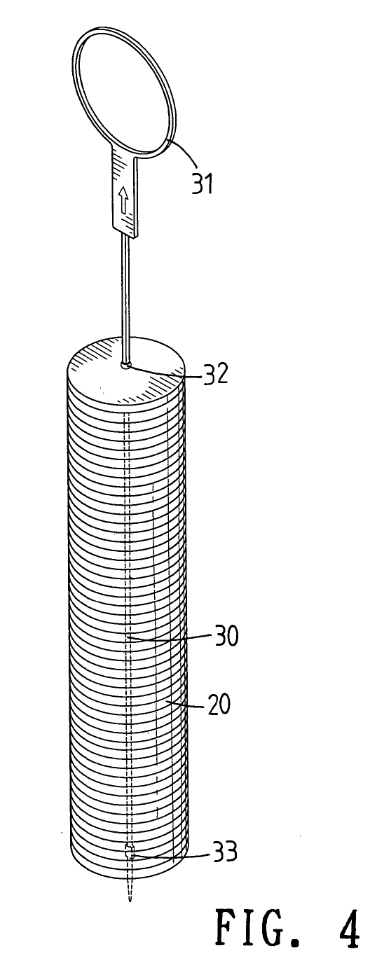

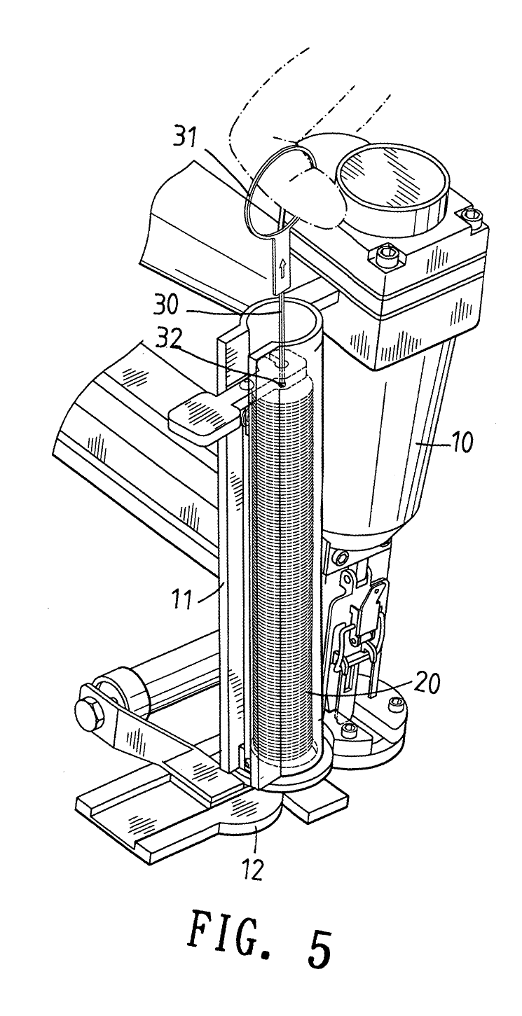

In assembly, referring to FIGS. 3-5 with reference to FIGS. 1 and 2, the thread 30 is extended through the through hole 21 of each of the washers 20. Then, the lower end of the thread 30 is formed with the fixing portion 33 by pressing or heating, so that the washers 20 are clamped between the protrusion 32 and the fixing portion 33 of the thread 30 to prevent the washers 20 from detaching from the thread 30. In addition, the thread 30 has a diameter slightly smaller than the diameter of the through hole 21 of each of the washers 20, thereby increasing the mounting speed of the washers 20. Then, the laminated washers 20 are placed into the receiving barrel 11 of the gun body 10. Then, as shown in FIG. 5, the user's one finger exerts a pulling force on the pull ring 31 of the thread 30 to pull the pull ring 31 of the thread 30 upward, so that the thread 30 is removed from the through hole 21 of each of the washers 20, and the washers 20 are positioned in the receiving barrel 11 of the gun body 10 as shown in FIG. 1.

Accordingly, the thread 30 made of plastic material is deformed when being heated or pressed, so that the lower end of the thread 30 is deformed by a pressing or heating process so as to form the fixing portion 33, thereby facilitating assembly of the washers 20. In addition, the lower end of the thread 30 is directly formed with the fixing portion 33, so that the laminated washers 20 are mounted on the thread 30 easily and rapidly. Further, after the laminated washers 20 are placed into the receiving barrel 11 of the gun body 10, the pull ring 31 of the thread 30 is pulled upward, so that the thread 30 is removed from the through hole 21 of each of the washers 20, and the washers 20 are mounted in the receiving barrel 11 of the gun body 10 easily and rapidly. Further, the thread 30 has a diameter slightly smaller than the diameter of the through hole 21 of each of the washers 20, thereby increasing the mounting speed of the washers 20. Further, the washers 20 are clamped between the protrusion 32 and the fixing portion 33 of the thread 30 to prevent the washers 20 from detaching from the thread 30 in the mounting process.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A caulking gun, comprising:
a gun body provided with a receiving barrel;
a plurality of washers mounted in the receiving barrel of the gun body; and
a washer positioning device mounted on the washers for positioning the washers.

2. The caulking gun in accordance with claim 1, wherein the receiving barrel of the gun body has an upper end formed with an opening and a lower end connected to a feed mechanism.

3. The caulking gun in accordance with claim 1, wherein the washers are laminated with each other, and each of the washers has a center formed with a through hole.

4. The caulking gun in accordance with claim 3, wherein the washer positioning device includes a thread extended through the through hole of each of the washers and having an upper end provided with a pull ring, and a lower end formed with a fixing portion rested on a lowermost one of the washers.

5. The caulking gun in accordance with claim 4, wherein the thread is made of plastic material.

6. The caulking gun in accordance with claim 4, wherein the thread is formed by a plastic injection molding process.

7. The caulking gun in accordance with claim 4, wherein the thread has a diameter slightly smaller than a diameter of the through hole of each of the washers.

8. The caulking gun in accordance with claim 4, wherein the fixing portion of the thread is formed by a pressing process.

9. The caulking gun in accordance with claim 4, wherein the fixing portion of the thread is formed by a heating process.

10. The caulking gun in accordance with claim 4, wherein the fixing portion of the thread has a flattened shape.

11. The caulking gun in accordance with claim 4, wherein the upper end of the thread is formed with a protrusion rested on an uppermost one of the washers.

12. The caulking gun in accordance with claim 1, wherein the pull ring of the thread is pulled upward, so that the thread is removed from the through hole of each of the washers, and the washers are mounted in the receiving barrel of the gun body.
